(19) United States
(12) Patent Application Publication
(10) Pub. No.: US 2003/0087442 A1
(43) Pub. Date: May 8, 2003

(54) Sample preparation system and associated apparatuses and method

(76) Inventors: Ioana Popa-Burke, Durham, NC (US); Jeffrey Murray, Raleigh, NC (US)

Correspondence Address: PARADIGM GENETICS, INC, 108 ALEXANDER DRIVE, P O BOX 14528, RTP, NC, 27709-4528, US

(21) Appl. No.: 10/008,348

(22) Filed: Nov. 8, 2001

(51) Int. Cl. G01N 35/10

(52) U.S. Cl. 436/43; 436/47; 436/48; 436/50; 436/180; 422/63; 422/67; 422/100; 435/DIG. 43; 435/DIG. 44; 435/DIG. 46; 435/DIG. 49

(57) ABSTRACT

A system for preparing a profiling sample is provided. The system comprises a profiling sample, a plurality of vessels, a plate defining a plurality of receptacles corresponding to, and configured to receive, the plurality of vessels, a dispensing unit for dispensing the profiling sample, and a weighing device. The plurality of receptacles are arranged according to a coordinate system. The dispensing unit has a robotic device in communication therewith, wherein the robotic device is configured to operably engage the plate so as to dispense a portion of the profiling sample into a selected vessel. The weighing device has a robotic device in communication therewith, wherein the robotic device is capable of operably engaging the selected vessel, removing the vessel from the corresponding receptacle and into operable engagement with the weighing device to perform a tare measurement of the vessel, and then replacing the vessel in the corresponding receptacle. The robotic device and weighing device are also capable of cooperating to perform a gross measurement, of the vessel and the portion of the profiling sample dispensed thereinto, using the same procedure for performing the tare measurement. The weight, and thus the mass, of the portion of the profiling sample may then be determined by deducting the tare measurement from the gross measurement. Associated apparatuses and a method are also provided.

### FIELD OF THE INVENTION

The present invention relates to a sample preparation system, and more particularly, to a high-throughput system for preparing samples in a multi-well tray and associated apparatuses and method.

### BACKGROUND OF THE INVENTION

Comprehensive functional genomic studies comprise many different procedures such as, for example, phenotypic profiling, gene expression profiling, biochemical profiling, and bioinformatics, wherein each procedure may comprise many sub-procedures. Historically, functional genomic studies require a significant amount of time and labor to complete the necessary tasks and are often characterized by low sample throughput. In some instances, tasks must be serially performed, while in other instances, several tasks may be performed in a parallel manner. Accordingly, scheduling of the required tasks is often a daunting exercise. One of the tasks which may slow the study procedure by lowering throughput and which may hinder efficient scheduling is the preparation of the required samples. Proper preparation of the samples is often critical in obtaining valid study results.

Accordingly, there exists a need for a system capable of preparing profiling samples in a multi-well plate in an expedient and efficient manner. Where sample preparation is directed to providing a certain sample mass in one or more of the wells, such a system should be capable of depositing the sample in the respective well and accurately determining the mass of that sample. Therefore, it would be desirable for such a system to be capable of preparing the sample with minimal transfer or handling of that sample, while keeping an accurate and modifiable record of each well within a plate, in addition to wells between plates. Further, it would be advantageous for such a system to be automated so as to reduce the necessary amount of manual handling by human operators in preparing the samples. Such automation would also be advantageous where gains in consistency, accuracy, repeatability, and reliability are realized within the sample preparation process. Accordingly, in addition to achieving high throughput in the sample preparation process, such a system would reduce, minimize, or eliminate a typical bottleneck in, for example, a biochemical profiling process, while also reducing personnel costs and labor.

### SUMMARY OF THE INVENTION

The above and other needs are met by the present invention which, in one embodiment, provides a high throughput system for preparing a profiling sample. The system comprises a profiling sample, a plurality of vessels, a plate defining a plurality of receptacles corresponding to, and configured to receive, the plurality of vessels, a dispensing unit for dispensing the profiling sample, and a weighing device. The plurality of receptacles are arranged according to a coordinate system. The dispensing unit has a robotic device in communication therewith, wherein the robotic device is configured according to the coordinate system so as to be registered with the plate. The robotic device is also configured to operably engage the plate so as to dispense a portion of the profiling sample into a selected vessel.

The weighing device also has a robotic device in communication therewith, wherein the robotic device is configured according to the coordinate system so as to be registered with the plate. The robotic device is further configured to operably engage the selected vessel such that, before the portion of the profiling sample is dispensed, the robotic device is capable of removing the selected vessel from the corresponding receptacle of the plate, transferring the selected vessel into operable engagement with the weighing device so as to allow the weighing device to perform a tare measurement of the selected vessel, and then replacing the selected vessel in the corresponding receptacle. After the portion of the profiling sample is dispensed into the selected vessel, the robotic device and weighing device are capable of cooperating to perform a gross measurement of the selected vessel and the portion of the profiling sample dispensed thereinto using the same procedure for performing the tare measurement. The weight, and thus the mass, of the portion of the profiling sample may then be determined by deducting the tare measurement from the gross measurement of the selected vessel.

Another advantageous aspect of the present invention comprises a high throughput dispensing apparatus adapted to dispense a profiling sample. The apparatus comprises a plurality of vessels, a plate defining a plurality of receptacles corresponding to, and configured to receive, the plurality of vessels, and a dispensing unit for dispensing the profiling sample. The plurality of receptacles is arranged according to a coordinate system. The dispensing unit has a robotic device in communication therewith, wherein the robotic device is configured according to the coordinate system so as to be registered with the plate. The robotic device is also configured to operably engage the plate so as to dispense a portion of the profiling sample into a selected vessel.

Still another advantageous aspect of the present invention comprises a high throughput weight measurement apparatus adapted to prepare a profiling sample. The apparatus comprises a plurality of vessels, a plate defining a plurality of receptacles corresponding to, and configured to receive, the plurality of vessels, and a weighing device. The plurality of receptacles are arranged according to a coordinate system. Further, a robotic device is in communication with the weighing device, wherein the robotic device is configured according to the coordinate system so as to be registered with the plate. The robotic device is also configured to operably engage the selected vessel such that, before a portion of a profiling sample is dispensed into the selected vessel, the robotic device is configured to remove the selected vessel from the corresponding receptacle of the plate and to transfer the selected vessel into operable engagement with the weighing device for the performance of a tare measurement of the selected vessel. The robotic device is further configured to then replace the selected vessel in the corresponding receptacle. After the portion of the profiling sample is dispensed into the selected vessel, the robotic device is configured to remove the selected vessel from the corresponding receptacle of the plate and to transfer the selected vessel into operable engagement with the weighing device for the performance of a gross measurement of the selected vessel and the portion of the profiling sample disposed therein. The robotic device is further configured to then replace the selected vessel in the corresponding receptacle. A weight, and thus the mass, of the portion of the profiling sample may thereafter be determined by deducting the tare measurement from the gross measurement of the selected vessel.

A further advantageous aspect of the present invention comprises a high throughput method for preparing a profiling sample in at least one selected vessel of a plurality of vessels, wherein the plurality of vessels is received in a plurality of corresponding receptacles defined by a plate and the vessels are arranged according to a coordinate system. First, an automated tare measurement of the selected vessel is performed, independently of the plate, with a weighing device. A portion of the profiling sample is then dispensed into the selected vessel with a dispensing device. Thereafter, a gross measurement of the selected vessel, having the portion of the profiling sample therein, is performed independently of the plate and with the weighing device, wherein the weight, and thus the mass, of the portion of the profiling sample may then be determined as the difference between the gross measurement and the tare measurement of the selected vessel.

Thus, embodiments of the present invention provide a system capable of preparing profiling samples in a multi-well plate in an expedient and efficient manner by implementing a multi-well plate having removable vessels with associated automation. Where sample preparation is directed to providing a certain sample mass in one or more of the wells, such a system is capable of depositing the sample in the respective well and accurately determining the weight of that sample by removing individual vessels from the plate in order to perform the respective weight measurements, from which sample mass may be determined. Since both the dispensing of the sample and the determination of the mass of the dispensed sample is accomplished through the use of one or more robotic devices, such a system is capable of preparing the sample with minimal transfer or handling of that sample. Further, automation allows such a system to keep an accurate and modifiable record of each vessel within a particular plate, in addition to vessels between plates. In addition, the automated system serves to reduce the necessary amount of manual handling of the plate, vessels, and/or sample by human operators when preparing the vessels and/or sample. Automation of a sample preparation system according to the present invention thereby realizes gains in consistency, accuracy, repeatability, and reliability within the sample preparation process. Accordingly, such a system provides high throughput in the sample preparation process, and thus reduces, minimizes, or eliminates a typical bottleneck in, for example, a biochemical profiling process, while also reducing personnel costs and labor. Thus, embodiments of a sample preparation system and associated apparatuses and method provide significant advantages as detailed further herein.

### BRIEF DESCRIPTION OF THE DRAWINGS

Having thus described the invention in general terms, reference will now be made to the accompanying drawings, which are not necessarily drawn to scale, and wherein:

FIG. 1 is a schematic representation of a multi-well plate defining a plurality of receptacles for receiving a corresponding plurality of removable vessels in a sample preparation system according to one embodiment of the present invention.

FIG. 2 is a schematic representation of a high throughput weight measurement apparatus implementing a multi-well plate with removable vessels according to one embodiment of the present invention.

FIG. 3 is a schematic representation of a high throughput sample dispensing apparatus implementing a multi-well plate with removable vessels according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

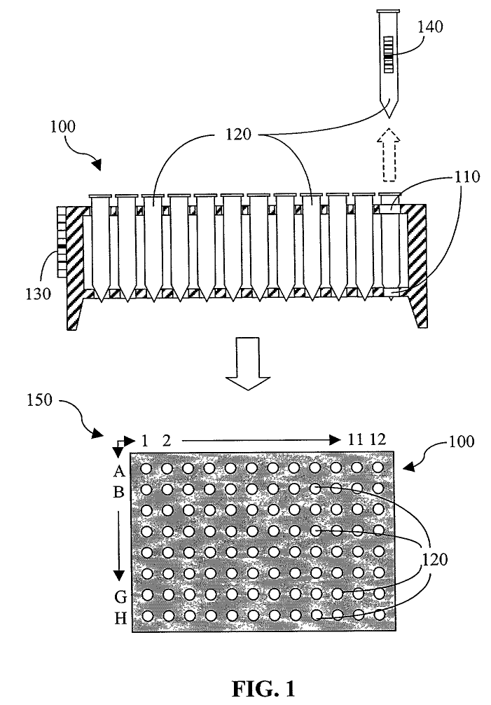

FIG. 1 provides a schematic representation of a plate having a plurality of removable wells as used in a sample preparation system according to one embodiment of the present invention, the plate being indicated generally by the numeral 100. As shown, the plate 100 defines a plurality of receptacles 110 configured to receive a corresponding plurality of removable wells, otherwise referred to herein as vessels or minitubes 120. Such a plate 100 is typically configured to receive, for example, 96 or 384 individual minitubes 120, in a configuration for laboratory applications, as will be appreciated by one skilled in the art, wherein a Falcon 96 well tube holder, manufactured by Becton Dickinson and Company (Franklin Lakes, N.J.), is but one example of a plate 100 as referred to herein. It will also be understood that, though the present invention is described herein in terms of 96 or 384 removable wells per plate, the system, apparatuses, and method may also be implemented with appropriate plates having any number of removable wells in accordance with the spirit and scope of the present invention.

Each plate 100 may further include a plate identification indicia 130 comprising, for example, a bar code or other indicia, capable of providing appropriate identification of the plate 100. In some instances, the individual minitubes 120 may also, or in the alternative to the plate identification indicia 130, comprise a minitube identification indicia 140 capable of providing appropriate identification of the minitube 120. Such a minitube identification indicia 140 would be useful, for example, in the event that a minitube 120 becomes separated from, and must be re-united with, the corresponding plate 100. However, for the sake of brevity, embodiments of the present invention utilizing the plate identification indicia 130 will be described herein, though it will be understood that many different methods and mechanisms, such as the minitube identification indicia 140, may be used to track and record minitubes within a plate in accordance with the spirit and scope of the present invention. Thus, according to one embodiment of the invention, the receptacles 110 may be arranged within the plate 100 according to a coordinate system, an example of which is generally indicated by the numeral 150, so as to indicate the location of each minitube 120 within the plate 100. In such an instance, the plate identification indicia 130 may cooperate with the coordinate system 150 to identify the individual minitubes 120 therein, without requiring the minitube identification indicia 140.

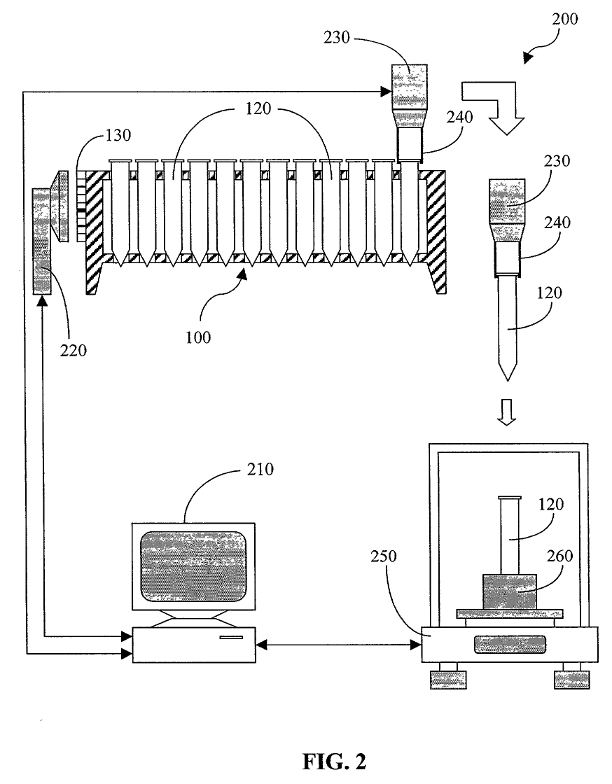

FIG. 2 is a schematic representation of a weight measurement apparatus, indicated generally by the numeral 200, as used in a sample preparation system according to one embodiment of the present invention. The weight measurement apparatus 200 is configured to receive the plate 100 in such a manner that the plate 100 is registered or otherwise aligned with the weight measurement apparatus 200 according to the coordinate system 150 (FIG. 1). For example, the plate 100 and the weight measurement apparatus 200 may be configured with each component having respective portions of a mechanically engageable device (not shown), wherein the device, when engaged, would cooperate to align the plate 100 with the weight measurement apparatus 200. Alternatively, the weight measurement apparatus 200 may include, for example, a computer device 210 in communication with an indicia reader 220 such as, for example, a bar code scanner for reading a bar code. In such an instance, the plate 100 may be configured to become registered with the weight measurement apparatus 200 upon proper engagement therewith and when the indicia reader 220 is capable of reading the plate identification indicia 130. Upon reading the plate identification indicia 130, the indicia reader 220 is further configured to send the corresponding information to the computer device 210, for example, to identify of the plate 100 or to facilitate the establishment of a file, such as a database, corresponding thereto.

The weight measurement apparatus 200 also comprises a robotic device 230 capable of and configured to engage each of the minitubes 120 when the corresponding plate 100 is registered with the weight measurement apparatus 200. The robotic device 230 is in communication with and controlled by the computer device 210. Accordingly, upon registration of the plate 100 with the weight measurement apparatus 200 and reading of the plate identification indicia 130 by the indicia reader 220, the robotic device 230 may be controlled and directed by the computer device 210 to interact with a specific minitube 120 according to the identification thereof, with respect to the coordinate system 150 (FIG. 1), as determined by the computer device 210. To facilitate interaction with a minitube 120, the robotic device 230 may further comprise an engagement device 240, also controlled by the computer device 210, capable of securely engaging the minitube 120 so as to allow the robotic device 230 to remove and replace the minitube 120 with respect to the corresponding receptacle 110 (FIG. 1) defined by the plate 100.

The weight measurement apparatus 200 also comprises a weighing device 250 in communication with the computer device 210. Such a weighing device 250 may comprise, for example, a Bohdan weighing station produced by the Mettler-Toledo Company (Columbus, Ohio). The weighing device 250 further includes a tube holder 260 configured to receive a minitube 120 transferred from the plate 100. Accordingly, the computer device 210 is configured to direct the robotic device 230 to engage a minitube 120 with the engagement device 240 and to remove the minitube 120 from the plate 100. The robotic device 230 is then directed to transfer the minitube 120 into the tube holder 260 of the weighing device 250. The weighing device 250, preferably having been calibrated to a zero value with the tube holder 260 in place, is then directed by the computer device 210 to tare, or perform a tare measurement, to determine the weight of the empty minitube 120. Since the computer device 210 has already determined the identity of the particular minitube 120, using the identification of the plate 100 from the plate identification indicia 130 and the location of that minitube 120 within the plate 100 according to the coordinate system 150 (FIG. 1), one skilled in the art will appreciate that an appropriate database may be prepared or otherwise established so as to allow the identity of that minitube 120, along with weight measurements and/or other information associated with the minitube 120 to be stored for future use. Upon completion of the tare measurement of the minitube 120, the robotic device 230 is further configured to remove the minitube 120 from the tube holder 260 and to replace the minitube 120 in the corresponding receptacle 110 in the plate 100. For a particular plate 100, the robotic device 230 and the weighing device 250 may be configured to tare any or all of the minitubes 120 and, in some instances, in a particular order or sequence.

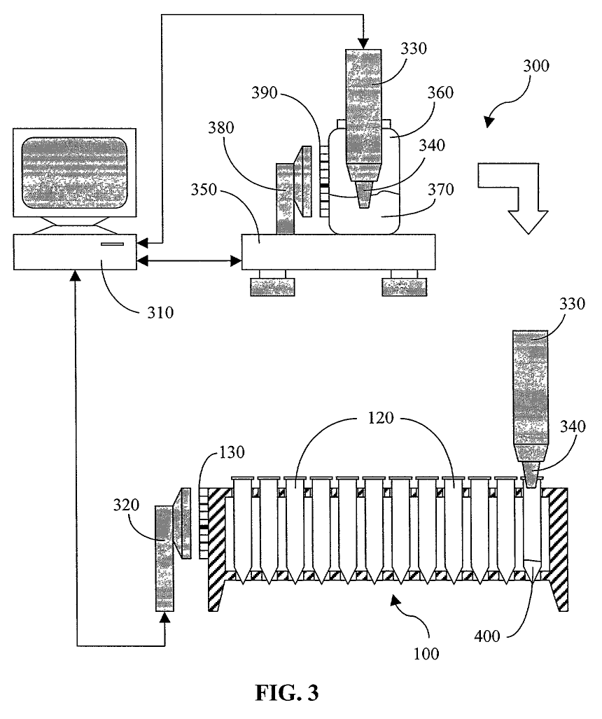

FIG. 3 is a schematic representation of a dispensing apparatus, indicated generally by the numeral 300, as used in a sample preparation system according to one embodiment of the present invention. The dispensing apparatus 300 is also configured to receive the plate 100 in such a manner that the plate 100 registered or otherwise aligned with the dispensing apparatus 300 according to the coordinate system 150 (FIG. 1). Note that, in some instances, the plate 100 may not have to be physically moved from the weight measurement apparatus 200 to the dispensing apparatus 300, since both the weight measurement apparatus 200 and the dispensing apparatus 300 may be configured to appropriately engage the plate 100 as disposed at a common site, wherein the plate 100 is registered or otherwise aligned with both apparatuses according to the established coordinate system 150 (FIG. 1). The dispensing apparatus 300 further comprises, for example, a computer device 310 in communication with an indicia reader 320 such as, for example, a bar code scanner for reading a bar code. In some instances, the computer device 310 and the indicia reader 320 comprising a portion of the dispensing apparatus 300 may be the same devices as the computer device 210 and the indicia reader 220 comprising a portion of the weight measurement apparatus 200, respectively. Accordingly, when the plate 100 is engaged and registered with the dispensing apparatus 300, the indicia reader 320 is capable of reading the plate identification indicia 130. Upon reading the plate identification indicia 130, the indicia reader 320 is further configured to send the corresponding information to the computer device 310 such that, for example, the appropriate database for that plate 100 may be accessed, updated, or otherwise modified.

The dispensing apparatus 300 further comprises a robotic device 330 capable of and configured to operably engage each of the minitubes 120 when the corresponding plate 100 is registered with the dispensing apparatus 300. The robotic device 330 is in communication with and controlled by the computer device 310. Accordingly, upon registration of the plate 100 with the dispensing apparatus 300 and reading of the plate identification indicia 130 by the indicia reader 320, the robotic device 330 may be controlled and directed by the computer device 310 to interact, through a dispensing tip 340, with a specific minitube 120 according to the identification thereof, with respect to the coordinate system 150 (FIG. 1), determined by the computer device 310. In addition, the dispensing apparatus 300 also comprises a dispensing station 350 in communication with the computer device 310 and configured to engage a bulk sample vial 360 containing a profiling sample 370. The dispensing station 350 may also include an indicia reader 380 configured to read a sample identification indicia 390 associated with the bulk sample vial 360, the sample identification indicia 390 comprising, for example, a bar code or other indicia. Accordingly, since the profiling sample 370 is to be dispensed into the minitubes 120 of the plate 100 engaged with the dispensing apparatus 300, the information read from the sample identification indicia 390 by the indicia reader 380 may be sent to the computer device 310 for association with the database records corresponding to the particular plate 100.

The robotic device 330 is configured with a dispensing tip 340 which, in one embodiment, is capable of interacting with the profiling sample 370 in the bulk sample vial 360 engaged with the dispensing station 350. Such a robotic device 330 may comprise, for example, an appropriately modified REDI robot produced by Zinsser Analytic Systems (Frankfurt, Germany). The dispensing tip 340 is directed by the computer device 310 to pick up and retain a predetermined amount or portion of the profiling sample 370 using, for example, a vacuum, a mechanical mechanism, or other suitable device. The computer device 310 is then configured to direct the robotic device 330 to remove the dispensing tip 340 from the bulk sample vial 360 and to move the dispensing tip 340 into operable engagement with a desired minitube 120 in the plate 100. Once the dispensing tip 340 is in proper engagement with the desired minitube 120, the computer device 310 directs the dispensing tip 340 to release the retained portion 400 of the profiling sample 370 into the minitube 120. It will be appreciated by one skilled in the art, however, that many different powdered sample dispensing systems may be implemented to accomplish the desired result of dispensing a predetermined amount or portion of a bulk profiling sample into individual minitubes 120 in accordance with the spirit and scope of the present invention, with the described dispensing apparatus 300 comprising but one such example. For instance, the dispensing apparatus 300 may comprise a powder reservoir having a feed mechanism engaged with a valve device for dispensing a certain amount of the bulk profiling sample into the desired minitube 120.

The computer device 310 may be further configured to direct the robotic device 330 to dispense a portion of the profiling sample 370 into any or all of the minitubes 120 in the plate 100 and, in some instances, in a desired sequence or order. However, in other instances, the computer device 310 may be configured to leave one or more of the minitubes 120 empty. Accordingly, the selected empty minitubes (not numbered) are appropriately designated as such in the database for the particular plate 100. These selected empty minitubes (not numbered) may be, for example, directed to receive control samples later dispensed by the robotic device 330 or other dispensing mechanism or may be directed to remain empty so as to comprise physical spacers between other filled minitubes 120. It follows that the database for the particular plate 100 may be accessed and updated by the computer device 310 to reflect which minitubes 120 within that plate 100 received a portion of the profiling sample 370 and which minitubes 120 were designated for control samples or the like and left empty.

Referring now to FIGS. 2 and 3, once the profiling sample dispensing procedure is completed by the dispensing apparatus 300, the plate 100 is again registered with the weight measurement apparatus 200. The indicia reader 230, as previously described, is configured to read the plate identification indicia 130 and to send the corresponding information to the computer device 210 such that the corresponding database for that plate 100 is accessed. Once the individual minitubes 120 are identified by the computer device 210, the computer device 210 directs the robotic device 230 to remove a selected minitube 120 from the plate 100 and to transfer the minitube 120 to the tube holder 260 of the weighing device 250. Such a procedure was previously described in conjunction with the taring of the minitubes 120 and will not be further discussed herein. The computer device 210 is thereafter configured to direct the weighing device 250, calibrated to a zero value, to perform a gross measurement of the weight of the minitube 120 containing a dispensed portion of the profiling sample 370. The gross measurement is read by the computer device 210, from the weighing device 250, and recorded in the corresponding database for the particular minitube 120. Thus, having previously obtained a tare measurement of a minitube 120 and now the corresponding gross measurement of the same minitube 120 containing a portion of the profiling sample 370, both measures being saved in a corresponding database, determination of the weight and/or the mass of the portion of the profiling sample 370 is a matter of deducting the tare measurement from the gross measurement, as will be appreciated by one skilled in the art. In some instances, the database may be configured to automatically make such a determination and to save the result as a corresponding record therein.

Note that, the computer device 210 may be configured to direct the robotic device 230 and weighing device 250 to perform a gross measurement of any or all of the minitubes 120, containing a portion of the profiling sample 370, in the plate 100. In some instances, the gross measurement of the minitubes 120 may be performed selectively or according to a predetermined sequence or order. Further, where one or more selected empty minitubes 120 have been designated, the computer device 210 may be configured to bypass a gross measurement of those empty minitubes 120. However, if a control sample or other material was deposited within the empty minitubes 120, the computer device 210 may, in such instances, direct the robotic device 230 and the weighing device 250 to also perform a gross measurement of those minitubes 120, the gross measurement results being appropriately recorded in the corresponding database for the plate 100. Note also that, in some instances, a particular desired weight or mass, or range thereof, of the portion of the profiling sample 370 in a minitube 120 may be designated and established as a parameter in the computer device 210. In such an instance, if the determined weight or mass of the portion of the profiling sample 370 dispensed into a minitube 120 does not correspond to the desired weight, mass, or range thereof, the database and/or computer device 210 may be configured to provide an indication or other alert of the nonconforming sample mass within the minitube 120, the identity of the corresponding plate 100, and/or the location of that minitube 120 within the plate 100. Accordingly, the weight of the portion of the profiling sample 370 within that minitube 120 may then be addressed and adjusted by a manual rework process or, in some instances, in an automated process similar to the dispensing process described herein. In addition, it will be realized and appreciated by one skilled in the art that an appropriate sample preparation system according to one embodiment of the present invention may be defined from the apparatuses and devices described herein. For example, one embodiment of such a sample preparation system may comprise a profiling sample, a removable-well plate housing a plurality of vessels or minitubes, a weight measurement apparatus, and a dispensing apparatus, as previously discussed.

Thus, embodiments of the present invention provide a system capable of preparing profiling samples in a multi-well plate in an expedient and efficient manner by implementing a multi-well plate having removable vessels and corresponding automation for dispensing and determining the weight of powdered sample portions within those vessels. Where sample preparation is directed to providing a certain sample weight or mass in one or more of the wells, such a system is capable of depositing the sample in the respective well and accurately determining the weight of that sample by removing individual vessels from the plate in order to perform the weight measurement thereof. Since both the dispensing of the sample and the determination of the mass of the dispensed sample are accomplished through the use of one or more robotic devices, such a system is capable of preparing the sample with minimal transfer or handling of that sample. Further, automation allows such a system to keep an accurate and modifiable record of each vessel within a particular plate in addition to vessels between plates. In addition, the automated system serves to reduce the necessary amount of manual handling of the plate, vessels, and/or sample by human operators when preparing the vessels and/or sample. Such automation of a sample preparation system realizes gains in consistency, accuracy, repeatability, and reliability within the sample preparation process, while contemporaneously recording, in a database form, applicable measurements and other information for particular plates and vessels within those plates. The resulting database and information therein may then be supplemented or modified by the results of subsequent tasks of the procedure or other portions of the study, or used to conduct an analysis at the conclusion of the study. Accordingly, such a system provides high throughput in the sample preparation process, and thus reduces, minimizes, or eliminates a typical bottleneck in, for example, a biochemical profiling process, while also reducing personnel costs and labor. Thus, embodiments of a sample preparation system and associated apparatuses and method provide significant advantages as described herein.

Many modifications and other embodiments of the invention will come to mind to one skilled in the art to which this invention pertains having the benefit of the teachings presented in the foregoing descriptions and the associated drawings. For example, the described system may be particularly adapted to handle samples in a liquid form, wherein the appropriate measurement criteria may comprise, for instance, the volume of the portion of the bulk sample within a minitube. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A high throughput dispensing apparatus adapted to dispense a profiling sample, said apparatus comprising:
a plurality of vessels;
a plate defining a plurality of receptacles corresponding to, and configured to receive, the plurality of vessels, the plurality of receptacles being arranged according to a coordinate system; and
a dispensing unit for dispensing the profiling sample and having a robotic device in communication therewith, the robotic device being configured according to the coordinate system so as to be registered with the plate, the robotic device being further configured to operably engage the plate so as to dispense a portion of the profiling sample into a selected vessel.

2. An apparatus according to claim 1 wherein the plate is configured to define ninety-six receptacles.

3. An apparatus according to claim 1 wherein the plate is configured to define three hundred and eighty-four receptacles.

4. An apparatus according to claim 1 further comprising an indicia operably engaged with at least one of the plate and the selected vessel, the indicia being configured so as to indicate information corresponding to the selected vessel.

5. An apparatus according to claim 4 further comprising a computer device operably engaged with the indicia, the computer device being configured to store, in a database, the information indicated by the indicia and corresponding to the selected vessel.

6. An apparatus according to claim 1 further comprising a computer device in communication with at least one of the dispensing unit and the robotic device corresponding to the dispensing unit.

7. An apparatus according to claim 6 wherein the computer device is further configured with a predetermined range criteria for the weight of the portion of the sample dispensed into the selected vessel.

8. An apparatus according to claim 7 wherein the computer device is further configured to direct at least one of the dispensing unit and the robotic device corresponding to the dispensing unit to dispense the weight of the portion of the sample into the selected vessel such that the weight is within the predetermined range criteria.

9. An apparatus according to claim 1 wherein the dispensing unit and the robotic device in communication therewith are further configured to selectively dispense a portion of the profiling sample into each of at least one selected vessel of the plurality of vessels.

10. An apparatus according to claim 1 wherein the dispensing unit and the robotic device in communication therewith are further configured to, selectively and in a predetermined order, dispense a portion of the profiling sample into each of at least one selected vessel of the plurality of vessels.

11. An apparatus according to claim 1 wherein the dispensing unit and the robotic device in communication therewith are farther configured to dispense a portion of the profiling sample into each of the plurality of vessels.

12. An apparatus according to claim 1 wherein the plurality of vessels further comprises a control vessel, and wherein the dispensing unit and the robotic device in communication therewith are further configured to not dispense a portion of the profiling sample into the control vessel.

13. An apparatus according to claim 12 wherein the dispensing unit is further configured to dispense a control sample into the control vessel, the control sample being adapted for comparison to the profiling sample.

14. An apparatus according to claim 1 wherein the dispensing unit is further adapted to dispense the profiling sample comprising a powder.

15. An apparatus according to claim 1 wherein the dispensing unit is further adapted to dispense the profiling sample comprising a homogenous free-flowing powder.

16. A high throughput weight measurement apparatus adapted to prepare a profiling sample, said apparatus comprising:
a plurality of vessels;
a plate defining a plurality of receptacles corresponding to, and configured to receive, the plurality of vessels, the plurality of receptacles being arranged according to a coordinate system; and
a weighing device having a robotic device in communication therewith, the robotic device being configured according to the coordinate system so as to be registered with the plate, the robotic device being further configured to operably engage the selected vessel such that, before a portion of a profiling sample is dispensed into the selected vessel, the robotic device is capable of removing the selected vessel from the corresponding receptacle of the plate, transferring the selected vessel into operable engagement with the weighing device so as to allow the weighing device to perform a tare measurement of the selected vessel, and then replacing the selected vessel in the corresponding receptacle, and such that, after the portion of the profiling sample is dispensed into the selected vessel, the robotic device is capable of removing the selected vessel from the corresponding receptacle of the plate, transferring the selected vessel into operable engagement with the weighing device so as to allow the weighing device to perform a gross measurement of the selected vessel and the portion of the profiling sample, and replacing the selected vessel in the corresponding receptacle, a weight of the portion of the profiling sample thereafter being determinable by deducting the tare measurement from the gross measurement of the selected vessel.

17. An apparatus according to claim 16 wherein the plate is configured to define ninety-six receptacles.

18. An apparatus according to claim 16 wherein the plate is configured to define three hundred and eighty-four receptacles.

19. An apparatus according to claim 16 further comprising an indicia operably engaged with at least one of the plate and the selected vessel, the indicia being configured so as to indicate information corresponding to the selected vessel.

20. An apparatus according to claim 19 further comprising a computer device operably engaged with the indicia, the computer device being configured to store, in a database, the information indicated by the indicia and corresponding to the selected vessel.

21. An apparatus according to claim 16 further comprising a computer device in communication with at least one of the weighing device and the robotic device corresponding to the weighing device.

22. An apparatus according to claim 21 wherein the computer device is configured to receive the tare measurement and the gross measurement from the weighing device and to compute the weight of the portion of the profiling sample in the selected vessel by determining the difference between the measurements.

23. An apparatus according to claim 22 wherein the computer device is further configured with a predetermined range criteria for the weight of the portion of the profiling sample in the selected vessel.

24. An apparatus according to claim 16 wherein the weighing device and the robotic device in communication therewith are further configured to perform a tare measurement of each of the plurality of vessels.

25. An apparatus according to claim 16 wherein the weighing device and the robotic device in communication therewith are further configured to perform a tare measurement of each of at least one selected vessel of the plurality of vessels.

26. A high throughput method for preparing a profiling sample in at least one selected vessel of a plurality of vessels, the plurality of vessels being received in a plurality of corresponding receptacles defined by a plate and arranged according to a coordinate system, said method comprising:
performing an automated tare measurement of the selected vessel independently of the plate with a weighing device;
dispensing a portion of the profiling sample into the selected vessel with a dispensing device; and
performing a gross measurement of the selected vessel, having the portion of the profiling sample therein, independently of the plate and with the weighing device, a weight of the portion of the profiling sample thereby being determinable as the difference between the gross measurement and the tare measurement of the selected vessel.

27. A method according to claim 26 further comprising updating an indicia with at least one of the tare measurement, the gross measurement, and the weight of the portion of the profiling sample, wherein the indicia is operably engaged with at least one of the plate and the selected vessel and is configured so as to indicate information corresponding to the selected vessel.

28. A method according to claim 27 further comprising storing the information indicated by the indicia and corresponding to the selected vessel in a database implemented on a computer device.

29. A method according to claim 26 wherein performing a tare measurement further comprises:
removing the selected vessel from the corresponding receptacle of the plate with a robotic device;
transferring the selected vessel with the robotic device into operable engagement with the weighing device so as to allow the weighing device to perform a tare measurement of the selected vessel; and
replacing the selected vessel in the corresponding receptacle of the plate with the robotic device.

30. A method according to claim 26 wherein performing a gross measurement further comprises:
removing the selected vessel from the corresponding receptacle of the plate with a robotic device;
transferring the selected vessel with the robotic device into operable engagement with the weighing device so as to allow the weighing device to perform a gross measurement of the selected vessel and the portion of the profiling sample disposed therein; and
replacing the selected vessel in the corresponding receptacle of the plate with the robotic device.

31. A method according to claim 26 wherein dispensing a portion of the profiling sample further comprises dispensing a portion of the profiling sample comprising a powder.

32. A method according to claim 26 wherein dispensing a portion of the profiling sample further comprises dispensing a portion of the profiling sample comprising a homogenous free-flowing powder.

33. A method according to claim 26 further comprising computing the weight of the portion of the profiling sample disposed in the selected vessel by deducting the tare measurement from the gross measurement.

34. A method according to claim 26 further comprising providing an alert if the computed weight of the portion of the profiling sample disposed in the selected vessel is outside a predetermined range criteria.

35. A method according to claim 26 wherein performing a tare measurement further comprises performing a tare measurement of each of the plurality of vessels.

36. A method according to claim 26 wherein performing a tare measurement further comprises performing a tare measurement of each of at least one selected vessel of the plurality of vessels.

37. A method according to claim 26 wherein dispensing a portion of the profiling sample further comprises selectively dispensing a portion of the profiling sample into each of at least one selected vessel of the plurality of vessels.

38. A method according to claim 26 wherein dispensing a portion of the profiling sample further comprises dispensing, selectively and in a predetermined order, a portion of the profiling sample into each of at least one selected vessel of the plurality of vessels.

39. A method according to claim 26 wherein dispensing a portion of the profiling sample further comprises dispensing a portion of the profiling sample into each of the plurality of vessels.

40. A method according to claim 26 wherein the plurality of vessels further comprises a control vessel and dispensing a portion of the profiling sample further comprises not dispensing a portion of the profiling sample into the control vessel.

41. A method according to claim 40 further comprising dispensing a control sample into the control vessel between the tare measurement and the gross measurement thereof.

42. A high throughput dispensing apparatus adapted to dispense a profiling sample, said apparatus comprising:
a plurality of vessels;
a means for defining a plurality of receptacles corresponding to, and configured to receive, the plurality of vessels, the plurality of receptacles being arranged according to a coordinate system; and
a profile sample dispensing means having a robotic device in communication therewith, the robotic device being configured according to the coordinate system so as to be registered with the plate, the robotic device being further configured to operably engage the plate so as to dispense a portion of the profiling sample into a selected vessel.

43. An apparatus according to claim 42 wherein the means for defining a plurality of receptacles is a plate configured to a plurality of receptacles.

44. An apparatus according to claim 42 wherein the means for defining a plurality of receptacles is a plate further comprising an indicia operably engaged with at least one of the plate and the selected vessel, the indicia being configured so as to indicate information corresponding to the selected vessel.

45. An apparatus according to claim 44 further comprising a computer device operably engaged with the indicia, the computer device being configured to store, in a database, the information indicated by the indicia and corresponding to the selected vessel.

46. An apparatus according to claim 42 wherein the profiling sample dispensing means is a dispensing unit further comprising a computer device in communication with at least one of the dispensing unit and the robotic device corresponding to the dispensing unit.

47. An apparatus according to claim 46 wherein the computer device is further configured with a predetermined range criteria for the weight of the portion of the sample dispensed into the selected vessel.

48. An apparatus according to claim 47 wherein the computer device is further configured to direct at least one of the dispensing unit and the robotic device corresponding to the dispensing unit to dispense the weight of the portion of the sample into the selected vessel such that the weight is within the predetermined range criteria.

49. An apparatus according to claim 42 wherein the profiling sample dispensing means and the robotic device in communication therewith are further configured to, selectively and in a predetermined order, dispense a portion of the profiling sample into each of at least one selected vessel of the plurality of vessels.

50. An apparatus according to claim 42 wherein the profiling sample dispensing means and the robotic device in communication therewith are further configured to dispense a portion of the profiling s ample into each of the plurality of vessels.

51. An apparatus according to claim 42 wherein the plurality of vessels further comprises a control vessel, and wherein the profiling sample dispensing means and the robotic device in communication therewith are further configured to not dispense a portion of the profiling sample into the control vessel.

52. An apparatus according to claim 51 wherein the profiling sample dispensing means is further configured to dispense a control sample into the control vessel, the control sample being adapted for comparison to the profiling sample.

53. An apparatus according to claim 42 wherein the profiling sample dispensing means is further adapted to dispense the profiling sample comprising a powder.

54. An apparatus according to claim 42 wherein the profiling sample dispensing means is further adapted to dispense the profiling sample comprising a homogenous free-flowing powder.

55. A high throughput system for preparing a profiling sample, said system comprising:
a profiling sample;
a plurality of vessels;
a plate defining a plurality of receptacles corresponding to, and configured to receive, the plurality of vessels, the plurality of receptacles being arranged according to a coordinate system;
a dispensing unit for dispensing the profiling sample and having a robotic device in communication therewith, the robotic device being configured according to the coordinate system so as to be registered with the plate, the robotic device being further configured to operably engage the plate so as to dispense a portion of the profiling sample into a selected vessel; and
a weighing device having a robotic device in communication therewith, the robotic device being configured according to the coordinate system so as to be registered with the plate, the robotic device being further configured to operably engage the selected vessel such that, before the portion of the profiling sample is dispensed, the robotic device is capable of removing the selected vessel from the corresponding receptacle of the plate, transferring the selected vessel into operable engagement with the weighing device so as to allow the weighing device to perform a tare measurement of the selected vessel, and then replacing the selected vessel in the corresponding receptacle, and such that, after the portion of the profiling sample is dispensed, the robotic device is capable of removing the selected vessel from the corresponding receptacle of the plate, transferring the selected vessel into operable engagement with the weighing device so as to allow the weighing device to perform a gross measurement of the selected vessel and the portion of the profiling sample, and replacing the selected vessel in the corresponding receptacle, a weight of the portion of the profiling sample thereafter being determinable by deducting the tare measurement from the gross measurement of the selected vessel.
